(19) United States
(12) Patent Application Publication
(10) Pub. No.: US 2023/0008244 A1
(43) Pub. Date: Jan. 12, 2023

(54) Device for Holding an Advertising Sign

(71) Applicant: Gregory Nathan, Gallo Manor (ZA)

(72) Inventor: Gregory Nathan, Gallo Manor (ZA)

(21) Appl. No.: 17/810,649

(22) Filed: Jul. 5, 2022

(30) Foreign Application Priority Data
Jul. 8, 2021 (ZA) 2021/04762

(51) Int. Cl. F16M 11/22; G09F 7/18

(52) U.S. Cl. CPC F16M 11/22; G09F 7/18; G09F 2007/1856; F16M 2200/08

(57) ABSTRACT

A device for holding an advertising sign, said device including one or more of the following: a first supporting means; and a second supporting means, the second supporting means extending diagonally from the operatively upper end of the first supporting means to a ground level, in use, wherein an operatively upper end of the first supporting means and an operatively upper end of the second supporting means define an opening, said opening operable to receive an advertising sign therein.

### FIELD OF THE INVENTION

This invention relates to a device for holding an advertising sign.

### BACKGROUND TO THE INVENTION

Conventionally, signage helps with sales and promotions, improved visibility as communication cues and help customers find what they are looking for. Currently, there are a variety of signage options available, including sign holders and banner holders. A user is currently able to choose from an assortment of sign holders, acrylic holders, frame holders, and metal sign holders to display their sign board.

An advertising sign is defined as a structure or device bearing a representation by a word, abbreviation thereof, letter, word, symbol, sign, figure, painting, drawing or other pictorial representation, or light that conveys information about something specific to the viewer in any place.

Advertising signs are typically used to advertise a product, event, and the like, and enables a viewer to identify a business or person at a glance. Advertising signs used on the exterior of a building or internally in the building are often designed to encourage the viewer to enter and are often used on the interior to encourage the viewer to explore the environment and participate in all that the space has to offer. In most cases, an advertising sign's effectiveness is determined by its use.

In the most basic sense, an advertising sign on the outside of your location provides information to the viewer about your business and makes the viewer aware of your existence. These advertising signs generally identify the company and allows the viewer to know that they have reached their intended destination. Signage is also a good way to advertise a brand. Essentially, it identifies the space as belonging to a business.

It is known in the industry, that advertising signs can be used to prompt the viewer or potential customer to make impulse buys. Often signs that advertise discounts or sales, entice the viewer to make a purchase. To entice the viewer from the outside, window displays can create curiosity and encourage the viewer to come inside.

It is known by those skilled in the art, that for the biggest impact, advertising signs should be as big as possible and should be placed in a prominent position to garner a maximum viewing audience. Once the viewer is inside a store with the intention to buy something, interior-signs can be used to point out other things the viewer may find interesting.

It is known by those in the industry, that wayfinding signage is often necessary for finding the location of a specific business, including signage related to a shopping mall, a hospital, or another business. Wayfinding signs are known to help get viewers from the street into the store or business, in the most convenient, safest manner possible. By having these types of signs, visitors and potential customers are less likely to get lost—which helps to avoid a situation that could reflect badly on the business. It is commonly known that a directional sign not only lets viewers know where to go, it makes others aware that your business is there.

Advertising signs may be used to complement other marketing efforts, for example, to enable people to recognise your logo and connect it to your business.

One of the most important parts of creating effective advertising signs is using an advert holder that matches the business's marketing priorities. From size to visibility, a variety of factors influence the value and usefulness of your signage.

It is commonly known by those in the industry, that there are several aspects that one should consider when choosing an advert holder for advertising a business or personal advertising.

The first aspect is the size of the advert holder. It is well known that advertising signs can range from large window signs and hanging in-store signage—to small signs used on desks, beside products or in in-store exhibits. Choosing the right size of advert holder is essential for showcasing your signage in an effective, visible manner.

The second aspect to consider is construction. For example, while advertising signs that are behind a counter or in the windows of a store will not necessarily need to be thick and sturdy sign holders. In contrast, an advertising sign that may be frequently bumped or brushed by customers or situated outdoors requires a sturdy, increased weight, high-quality sign holder to keep the sign in place. For example, for advertising signs that are frequently bumped by shopping carts and other items, it may be preferable to choose a thick plastic that can tolerate bumps and scratches. It is also important to choose a sign holder that is stable and not prone to movement. For outdoor advertising signs, it is necessary that the advertising sign does not move from its place during average wind speeds as it could fly into the road and hurt pedestrians or damage passing cars.

The third aspect to consider is versatility. It is known in the industry, that one must consider whether a sign holder needs to hold one type of advertising sign forever or if one needs a more versatile sign holder to hold a variety of advertising signs that change every week. Versatility is one of the most important aspects to consider when selecting a sign holder. For example, advert holders with a simple top, side or bottom-loading design make switching signage easy, giving businesses extra versatility to change its marketing message when it needs to.

The fourth aspect to consider is purpose. The purpose of your signage will determine the type of advert holder that is the most appropriate. For example, floor signage is best suited to an angled advert holder displaying the adverts on both sides, for example an A frame, while table signage is usually more suitable for a side loading advertising frame. The purpose of stacking a volume of advert holders is another important measure where a volume of advert holders is required to be transported and handled. Stacking advert holders effectively often requires reduction of the advert holder frame height above the ground in order to reduce total weight of the stacked advert holders.

The fifth aspect to consider is visibility. It is commonly known by those in the industry, that a key element of effective marketing is visibility. For example, it is widely known that no matter how effective your marketing message might be, it is unlikely to have any real effect on viewers (and prospective customers) if it is not optimised for visibility. It is generally known that some advert holders offer better visibility, particularly from certain angles, than other types, for example an advert holder that holds a sign perpendicular to the ground might be better suited to the sightline of drivers of cars driving past it than advertising signs that are not angled perpendicular to the ground.

Conventionally, many of the lightweight sign holders currently available relate to an advertising sign supported in a frame which has been formed from aluminum or other type of extrusions. Typically, such extrusions are formed with a slot or bordered frame for receiving the edge of the board, the uppermost edge of the board being secured in its slot. The frame then generally consists of two elongated components comprising a slot extending over the length thereof and having a cross-sectional portion where the width is greater than or equal to that of the entrance to the slot and where the edge of the advertising sign inserts into the slot. Generally, in this example, the elongated components are not designed to be stackable (e.g. stacking multiple devices in the boot of a car), wind resistant for high wind speeds and compact in relation to the advertising board being displayed and/or built from more than one component e.g. using separately installed flange components each side of the entrance to the slot in order to provide connection between the two elongated components.

It will be appreciated, that the advert holders set out in the example above invariably involves a complex assembly process. Similarly, the majority of conventional advert holders usually require assembly, in so far as the elongated components of the sign board are required to be attached to the upper edge of a sign board. This may require a user to drill through the each of the elongated components and through the upper edge of a sign board located therein and then passing a fixing member such as a plastic bolt therethrough or require attachment of the advert board for the entire length of the advert holder.

Furthermore, it is known in the industry, that the most common types of advert holders employ one or more support legs, edges or posts, a sign holding frame attached to the legs, and one or more sign faces. These advert holders are generally constructed out of wood. However, it is widely known that some advertising signs also used in real estate sales, employ metal frames and metal or plastic sign faces.

It will be appreciated by those skilled in the art, that an overwhelming number of these conventional advert holders may inhibit the extent of the advertising sign's area being displayed due to the sign holder's volume which covers a large portion of the advertising sign as the advertising holder needs to be held in place in outdoor windy environments. Therefore, such advert holders are voluminous and not designed to maximise stackability with reduced weight in small-volume spaces (e.g. boot of a car), thus adding unnecessary weight to their devices and not being able to maximise the presentation of information on the advert being presented in relation to the sign holder.

It will also be appreciated by those in the industry, that most advert holders are cumbersome in their assembly, difficult to utilise properly, and often unmanageable in respect of a single person easily transporting and assembling same without aids. They also occupy a great deal of space in storage and during transportation. Consequently, it will be appreciated by those skilled in the art that there exists a long-felt need for an advert holder that is stable, safe to handle, durable, quick to erect, not voluminous and cost effective in relation to the square meter of advert being displayed, compact and stable in high winds and further provides an increased exposure area in terms of the advertising sign it houses.

### Object of the Invention

It is an object of the invention to provide a device for holding an advertising sign which provides the advantages and addresses some of the issues and deficiencies described above.

### SUMMARY OF THE INVENTION

According to a first aspect of the invention, there is provided a device for holding an advertising sign, said device including one or more of the following:

a first supporting means; and

a second supporting means, the second supporting means extending diagonally from the operatively upper end of the first supporting means to a ground level, in use,

wherein an operatively upper end of the first supporting means and an operatively upper end of the second supporting means define an opening, said opening operable to receive an advertising sign therein.

In an embodiment of the invention, said device further includes a third supporting means, said third supporting means being operable to extend from an operatively lower end of the first supporting means along the ground level.

In an embodiment of the invention, said device further includes a fourth supporting means, said fourth supporting means being operable to extend from an operatively lower end of the second supporting means along the ground level.

In an embodiment of the invention, said device further includes a fifth supporting means, said fifth supporting means being operable on any edge of the device to provide a supporting means for moment forces on the device and to add as a safety handling feature by reducing sharp edges.

In an embodiment of the invention, said device is provided in the form of a single, elongate sheet deformed around multiple axes. In this embodiment, said device is provided in the example form of a single, elongate sheet deformed along its longitudinal axis to be sufficiently stable in its transverse and lateral axes to hold an advertising sign, in use.

In another embodiment, said device includes one or more flanges, projecting from one or more sides of the device, operable to receive an advertising sign therein, in use. In this embodiment, said one or more flanges project from the first supporting means, in use.

In an embodiment, said device is operable to be stacked, one on top the other.

In an embodiment, said device is operable to enable display of an advertising sign positioned in landscape or portrait mode with best viewing ratios for example 1.33 (length to height ratio) that would include dimensions guided by regulatory bodies governing signage.

In an embodiment, the device is operable to enable display of a larger advertising sign and supporting the weight of the larger advertising sign by inserting one vertical edge of the advertising sign in a one device and the other vertical edge of the advertising sign into another device thus connecting the advertising sign with two devices.

In an embodiment of the invention, said device is manufactured from a highly dense (gram per cubic metre) and/or durable and/or cost-effective material.

In an embodiment, the device is operable to increase a surface area of the advertisement sign which is visible to a third party and reduce the volume of the device in so far as the device does not extend across the length of the sign board.

In an embodiment, all supporting means are operable to increase stability in the context of wind resistance of the device and its associated advertising sign board.

In an embodiment, said device defines one or more holes, said holes being operable on the advert holder or the advertising sign board to allow for wind flow through the advertising sign to reduce its wind resistance.

In an embodiment, the device surface area of the third and fourth supporting means may differ to balance the moment forces of high wind speeds.

### BRIEF DESCRIPTION OF THE DRAWINGS

These and other features of this invention will become apparent from the following description of one example described with reference to the accompanying drawings in which:

FIG. 1 shows a posterior diagrammatic view of a device for holding an advertising sign, in accordance with an embodiment of the invention;

FIG. 2 shows an anterior diagrammatic view of a device for holding an advertising sign, in accordance with an embodiment of the invention;

FIG. 3 shows a posterior diagrammatic view of a device for holding an advertising sign, in use in accordance with an embodiment of the invention; and

FIG. 4 shows a diagrammatic cross-section of a device for holding an advertising sign, in use in accordance with an embodiment of the invention.

### DETAILED DESCRIPTION OF THE DRAWINGS

The following description of the invention is provided as an enabling teaching of the invention. Those skilled in the relevant art will recognize that many changes can be made to the embodiment described, while still attaining the beneficial results of the present invention. It will also be apparent that some of the desired benefits of the present invention can be attained by selecting some of the features of the present invention without utilizing other features. Accordingly, those skilled in the art will recognize that modifications and adaptions to the present invention are possible and can even be desirable in certain circumstances and are a part of the present invention. Thus, the following description is provided as illustrative of the principles of the present invention and limitation thereof.

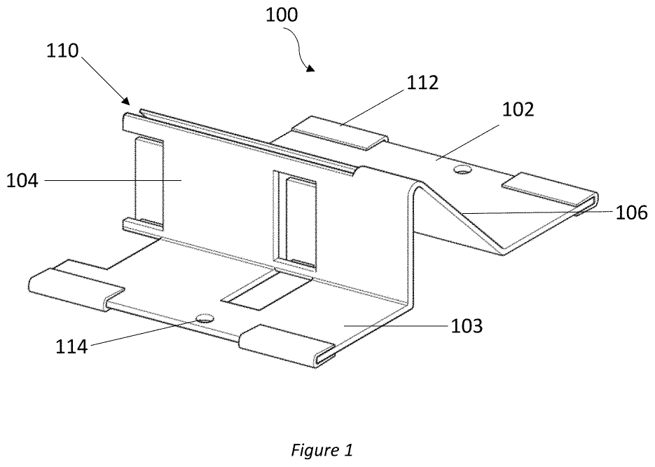

In FIG. 1, a device being the advert holder that holds an advertising sign in place is generally described with reference to numeral 100.

The device 100 is provided in the example form of a single sheet of flat material, such as a steel material or the like with high density. The device 100 includes flat, horizontal portions 102 and 103, a vertical portion 104 and a diagonal portion 106. A hole is positioned in one or more horizontal portions 102 and 103 to allow the device to be versatile in use on the ground where a short peg can be hammered through the hole onto a soft surface to keep it in place. A centered subtracted cutout is positioned in the horizontal portion 102 or 103 to serve the purpose of easy, safe handling of the device or stacked devices.

The horizontal portions 102 and 103 are flat with the ground and provides support for the device. The vertical portion 104 extends perpendicularly upward from the horizontal portion 102. The diagonal portion 106 extends downward at an angle, from the vertical portion 104.

The juncture between the vertical portion 104 and the diagonal portion 106 defines a slot 110, along the width of the device. The slot 110 receives the advertisement sign, in use.

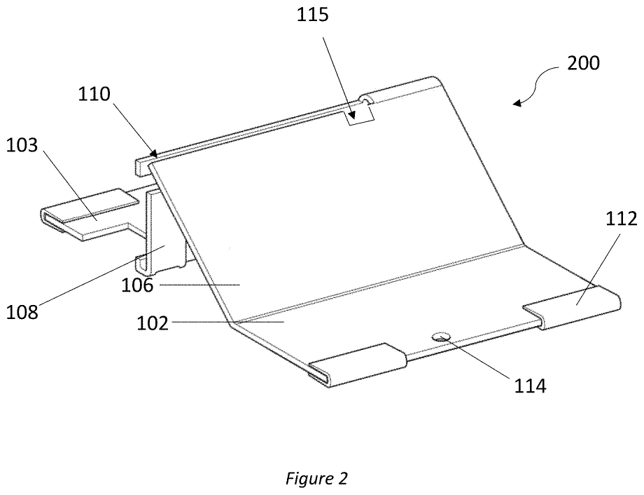

FIG. 2, device for displaying an advertising sign is generally described with reference to numeral 200.

Please note that with reference to FIG. 2, the same reference numerals (e.g., 102, 104 etc.) will be used to describe the same aspects as described with reference to FIG. 1.

The device 200 contains horizontal portions 102 and 103, which are flat with the ground and provides support for the device and to reduce its voluminous structure above the ground whilst also increasing stability of the structure above the ground. The horizontal portion 103 and vertical portion 104 specifically contain subtracted cut out areas that relate to the positioning of flanges 108 which are part of the same elongate material used for the device. The device further contains a vertical portion 104, which extends perpendicularly upward from the horizontal portion 103. The device further contains a diagonal portion 106 extends downward at an angle, from the vertical portion 104.

The device includes a support flange 108 which is formed from a laser cut and bent on the metal elongate and sits on the inside of the vertical portion 104 and which is operable to receive the advertisement sign, in use.

A slot 110, is defined along the width of the device. The slot 110 receives the advertisement sign, in use. The device is the major carrier of the inertial forces that are applied to the advertisement sign. The slot 110 is maximized to the center point of the advertisement sign center of gravity to minimize the inertial velocity difference between any 2-point forces applied on the advertising sign, thus reducing rotation of the device. A cutout 115 at the edge of the slot 100 provides an additional vertical edge support insert for the advertising sign.

The extrusion inserts 112, on the edges of the horizontal portions 102 and 103, are provided in the example form of a stabilizing material like rubber and support the reduction of rotation due to moment forces on the advertising sign 200 and the device, in order to make the device more versatile to be positioned on smooth or paved surfaces.

The vertical portions 102 and 103 may include openings, which allow wind to flow through the advertising sign to reduce its wind resistance.

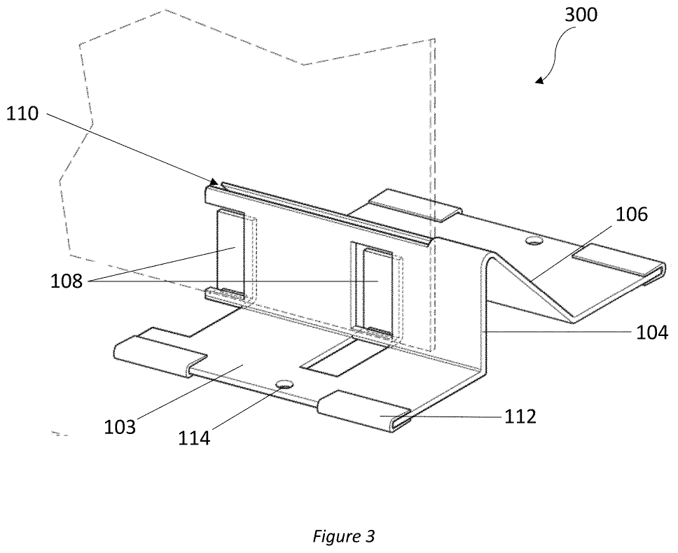

FIG. 3, device for holding an advertising sign, in use, is generally described with reference to numeral 300 and shows how the advertising sign slides into the device.

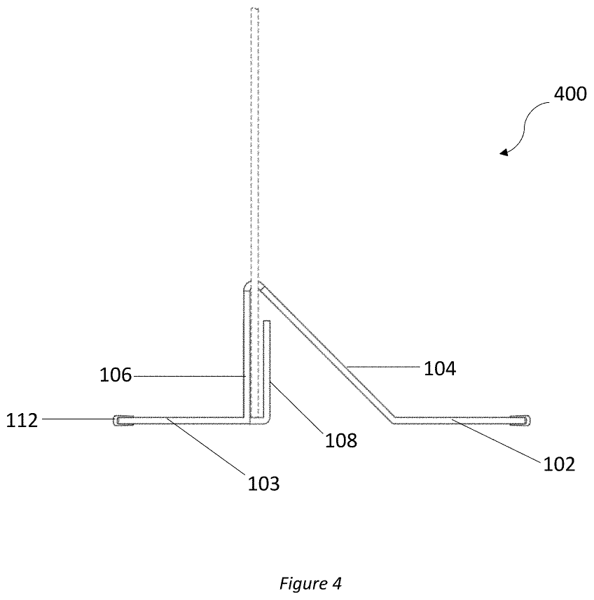

FIG. 4, device for holding an advertising sign, in use, is generally described with reference to numeral 400.

The triangle apex height and area between vertical portion 104 and diagonal 106 is minimized to increase stackability and improve cost effectiveness.

A scientific calculation is performed to determine the weight and adjustment of weight to the sign holder. The weight of the sign holder is largely designed around its performance in outdoor windy situations. Weight of the sign holder needs to be minimized for various reasons, including transport, ease of being stackable and cost effectiveness.

Example of Advertising Board:
size: 0.6 m (length), 0.450 m (width)
Air Temperature—23 degrees Celsius

Scientific calculation of the advert holder for outdoor usage in windy conditions:

$$\begin{matrix}Wind load on board = 0.5 ρ {v}^{2} A c \\ = {0.5}^{⋆} {1.1928}^{⋆} 10 \hat{} {2}^{⋆} {( {0.6}^{⋆} 0.45 )}^{⋆} 1 \\ = 16.1 N\end{matrix}$$

An equivalent reactive weight of a minimum of 16.1/9.8=1.64 kg is required in wind conditions of 10 m/s wind velocity.

1. A device for holding an advertising sign, said device comprising:
a first supporting means; and
a second supporting means, the second supporting means extending diagonally from the operatively upper end of the first supporting means to a ground level, in use,
wherein an operatively upper end of the first supporting means and an operatively upper end of the second supporting means define an opening, said opening operable to receive an advertising sign therein.

2. A device as claimed in claim 1, wherein the device further comprises a third supporting means, said third supporting means being operable to extend from an operatively lower end of the first supporting means along the ground level.

3. A device as claimed in claim 2, wherein the device further comprises a fourth supporting means, said fourth supporting means being operable to extend from an operatively lower end of the second supporting means along the ground level.

4. A device as claimed in claim 3, wherein the device further comprises a fifth supporting means, said fifth supporting means being operable on any edge of the device to provide a supporting means for moment forces on the device and to add as a safety handling feature by reducing sharp edges.

5. A device as claimed in claim 1, wherein said device is provided in the form of a single, elongate sheet deformed around multiple axes.

6. A device as claimed in claim 5, wherein the said device is provided in the example form of a single, elongate sheet deformed along its longitudinal axis to be sufficiently stable in its transverse and lateral axes to hold an advertising sign, in use.

7. A device as claimed in claim 1, wherein the device includes one or more flanges, projecting from one or more sides of the device, operable to receive an advertising sign therein, in use.

8. A device as claimed in claim 7, wherein the one or more flanges project from the first supporting means, in use.

9. A device as claimed in claim 1, wherein the device is operable to be stacked, one on top the other.

10. A device as claimed in claim 1, wherein the said device is operable to enable display of an advertising sign positioned in landscape or portrait mode with best viewing ratios for example 1.33 (length to height ratio) that would include dimensions guided by regulatory bodies governing signage.

11. A device as claimed in claim 1, wherein the device is operable to enable display of a larger advertising sign and supporting the weight of the larger advertising sign by inserting one vertical edge of the advertising sign in a one device and the other vertical edge of the advertising sign into another device thus connecting the advertising sign with two devices.

12. A device as claimed in claim 1, wherein the said device is manufactured from a highly dense (gram per cubic metre) and/or durable and/or cost-effective material.

13. A device as claimed in claim 1, wherein the said device is operable to increase a surface area of the advertisement sign which is visible to a third party and reduce the volume of the device in so far as the device does not extend across the length of the sign board.

14. A device as claimed in claim 1, wherein all supporting means are operable to increase stability in the context of wind resistance of the device and its associated advertising sign board.

15. A device as claimed in claim 1, wherein the said device defines one or more holes, said holes being operable on the advert holder or the advertising sign board to allow for wind flow through the advertising sign to reduce its wind resistance.

16. A device as claimed in claim 1, wherein the device surface area of the third and fourth supporting means may differ to balance the moment forces of high wind speeds.
